(19) United States
(12) Patent Application Publication
(10) Pub. No.: US 2026/0099957 A1
(43) Pub. Date: Apr. 9, 2026

(54) FAST MODE AND UPSCALE FOR TEXT TO IMAGE

(71) Applicant: ADOBE INC., San Jose, CA (US)

(72) Inventors: Peitong Chen, Cambridge, MA (US); Tracy Hirai, San Jose, CA (US); Geireann Christoph Lindfield Roberts, San Francisco, CA (US); Thomas Ansley Hightower, Sunnyvale, CA (US); Jinrong Xie, San Jose, CA (US); Morgan David de Lossy, San Francisco, CA (US)

(21) Appl. No.: 19/220,391

(22) Filed: May 28, 2025

Related U.S. Application Data
(60) Provisional application No. 63/704,367, filed on Oct. 7, 2024.

(51) Int. Cl. G06T 11/00; G06T 5/70

(52) U.S. Cl. CPC G06T 11/00; G06T 5/70; G06T 2200/24; G06T 2207/20084

(57) ABSTRACT

A method, apparatus, non-transitory computer readable medium, and system for generating a synthetic image includes obtaining an input prompt and an indication of a first image generation mode. In some cases, a user selects, via a user interface, a first image generation model from a set of image generation models including the first image generation model and a second image generation model. The first image generation model corresponds to the first image generation mode and the second image generation model corresponds to the second image generation mode different from the first image generation mode. The selected image generation model is used to generate a synthetic image based on the input prompt and the first image generation mode.

### CROSS-REFERENCE TO RELATED APPLICATIONS

This application is based on and claims priority under 35 USC § 120 of U.S. Patent Application No. 63/704,367 filed on Oct. 7, 2024, in the United States Patent Office, the entire contents of which are incorporated herein by reference for their entirety.

### BACKGROUND

The following relates generally to image processing, and more specifically to image processing using a machine learning model. Machine learning algorithms build a model based on sample data, known as training data, to make a prediction or a decision in response to an input without being explicitly programmed to do so. One area of application for machine learning is image generation.

For example, a machine learning model can be trained to predict information for an image in response to an input prompt, and to then generate an output based on the predicted information. In some cases, the prompt can be used to perform complex image manipulation and compositing. The generated output provides for a user to edit an image and generate an image with desired features and therefore makes image generation easier for a layperson and also more readily automated.

### SUMMARY

The present disclosure describes systems and methods for image generation. Embodiments of the present disclosure include an image generation model based on a distilled diffusion network. The image generation model is configured to generate a set of synthetic images based on an input prompt, received from a user via a user interface, in a fast mode. In some cases, at least one of the set of synthetic images are further upscaled, by the user via the user interface, resulting in generation of high-resolution images based on the synthetic images.

A method, apparatus, and non-transitory computer readable medium for image processing are described. One or more aspects of the method, apparatus, and non-transitory computer readable medium include obtaining an input prompt and an indication of a first image generation mode; selecting a first image generation model from a set of image generation models including the first image generation model and a second image generation model, wherein the first image generation model corresponds to the first image generation mode and the second image generation model corresponds to the second image generation mode different from the first image generation mode; and generating, using the first image generation model, a synthetic image based on the input prompt.

A method, apparatus, and non-transitory computer readable medium for image processing are described. One or more aspects of the method, apparatus, and non-transitory computer readable medium include providing an input prompt user interface element and a mode selection user interface element; receiving and input prompt via the input prompt user interface element; receiving an indication of a first image generation mode via the mode selection user interface element; selecting a first image generation model from a plurality of image generation models based on the indication of the first image generation mode; and generating, using the first image generation model, a synthetic image based on the input prompt.

An apparatus and system for image processing are described. One or more aspects of the apparatus and system include a memory component; a processing device coupled to the memory component, the processing device configured to perform operations comprising: obtaining an input prompt and an indication of a first image generation mode; selecting a first image generation model from a set of image generation models including the first image generation model and a second image generation model, wherein the first image generation model corresponds to the first image generation mode and the second image generation model corresponds to the second image generation mode different from the first image generation mode; and generating, using the first image generation model, a synthetic image based on the input prompt.

### BRIEF DESCRIPTION OF THE DRAWINGS

FIG. 1 shows an example of an image processing system according to aspects of the present disclosure.

FIG. 2 shows an example of a method for generating an image according to aspects of the present disclosure.

FIG. 3 shows an example of a user interface according to aspects of the present disclosure.

FIG. 4 shows an example of a first image generation mode according to aspects of the present disclosure.

FIG. 5 shows an example of upscaling a synthetic image generation according to aspects of the present disclosure.

FIG. 6 shows an example of an image generation history according to aspects of the present disclosure.

FIG. 7 shows an example of a latent diffusion architecture according to aspects of the present disclosure.

FIG. 8 shows an example of a U-net architecture according to aspects of the present disclosure.

FIG. 9 shows an example of a denoising diffusion process according to aspects of the present disclosure.

FIG. 10 shows an example of a method for image processing according to aspects of the present disclosure.

FIG. 11 shows an example of a method for training a machine learning model according to aspects of the present disclosure.

FIG. 12 shows an example of a method for training a diffusion model according to aspects of the present disclosure.

FIG. 13 shows an example of a computing device according to aspects of the present disclosure.

FIG. 14 shows an example of an image processing apparatus according to aspects of the present disclosure.

FIG. 15 shows an example of an image generation model according to aspects of the present disclosure.

FIG. 16 shows an example of a diffusion transformer (DiT) architecture according to aspects of the present disclosure.

### DETAILED DESCRIPTION

The present disclosure describes systems and methods for image generation. Embodiments of the present disclosure include an image generation model based on a distilled diffusion network. The image generation model is configured to generate a set of synthetic images based on an input prompt, received from a user via a user interface, in a fast mode. In some cases, at least one of the set of synthetic images are further upscaled, by the user via the user interface, resulting in generation of high-resolution images based on the synthetic images.

Machine learning algorithms build a model based on sample data, known as training data, to make a prediction or a decision in response to an input without being explicitly programmed to do so. For example, a machine learning model may generate a new output based on using training information obtained by learning patterns, features, and distributions from a dataset. Such an ability to predict or simulate makes machine learning models extremely invaluable for tasks where new content creation is desired.

In some cases, machine learning models are used for image generation. Recently, diffusion models, which are a category of machine learning models, have been used to generate images. The diffusion models work by initially adding noise to an image and then learning to reverse this process. The model gradually transforms a sample of random noise into a coherent image, learning to denoise through a series of steps. However, existing diffusion models use several iterations in the generative process which results in large-sized models that use a high number of computational resources. Moreover, a reduction in the number of iterations results in a significant deterioration in the performance of the diffusion model.

By contrast, embodiments of the present disclosure include an image generation model comprising a diffusion network. In some cases, the diffusion network is distilled during the generative reverse diffusion process to four-steps and the parameters of the diffusion network are updated based on the distillation results. Accordingly, by using a distilled diffusion network, embodiments of the present disclosure are able to quickly and accurately generate an image based on the prompt (e.g., text prompt provided by the user via the user interface of the user device).

Embodiments of the present disclosure are configured to perform image generation based on a fast mode. For example, the fast mode includes an image preview mode and a full-resolution mode. In some examples, by implementing the fast mode based on the distilled diffusion network of the image generation model, embodiments of the present disclosure are able to generate images that align with an input prompt within a time that is significantly less than existing image generation models. For example, the distilled image generation model of the present disclosure generates an image in 2-3 seconds (compared to 12-15 seconds with existing image generation methods).

In some cases, the image preview mode generates low-resolution images, and the full-resolution mode generates high-resolution images (e.g., upscaled images with enhanced details). For example, the image generation model provides different results for various prompt types based on the user's intentions. In some examples, by separating the image preview mode from the full-resolution mode, embodiments of the present disclosure are able to provide for users to iterate faster at low resolution and edit or enhance the input prompts for quick ideation. Additionally, by providing the users with an option of selecting the fast mode, embodiments enable users to select the appropriate generation option and experience.

An embodiment of the present disclosure is configured to generate low-resolution images (512×512) in the image preview mode. In some cases, a user can choose to upscale at least one of the low-resolution images to generate a high-resolution (2k×2k) image by clicking an upscale option in the low-resolution image. Additionally, an embodiment of the present disclosure provides the user with an image session history. In some cases, the image session history provides for the user to view the previously generated images during their session and perform image upscaling to a high-resolution image.

As described herein, an input prompt refers to input text that indicates an object. For example, the input prompt is “a rabbit eating soup”. In some cases, a first image generation mode refers to a fast mode selected by a user via a user interface of the user device. In some cases, the first image generation mode (i.e., fast or accelerated mode) is used to generate an image (e.g., a synthetic image of a low resolution, such as 512×512 pixels) in about 2-3 seconds (i.e., compared to 12-15 seconds with existing image generation methods).

In some cases, a second image generation mode refers to a mode slower than the first image generation mode (fast mode) selected by a user via a user interface of the user device. For instance, the user implements the second image generation mode based on upscaling the synthetic image generated in the first image generation mode. In some cases, the second image generation mode is used to generate an image (e.g., a high resolution image, such as 2k×2k pixels) in about 5-6 seconds. For instance, the high resolution image depicts the same content (i.e., same element) as the synthetic image generated in the first image generation mode.

As described herein, the second image generation mode is associated with a second image generation model. In some cases, the second image generation model is a diffusion model based on a neural network architecture such as a U-Net. Additionally, the first image generation mode is associated with a first image generation model. In some examples, the first image generation model is based on reducing the size and compute resources for the diffusion model.

As described herein, the first image generation model is capable of performing fast and accurate four-step image generation. The first image generation model performs a stable, four-step transformation via a training method based on a distribution-matching loss, which guides the first image generation model to produce images in the same distribution as a pre-trained, multi-step parent generation model. The distribution-matching approach leads to more stable outputs, even when the first image generation model is given complex guidance features such as from text prompts.

The distribution-matching loss includes a first term from the parent model, and a second term from an unlocked and jointly-trained model. As used herein, the first term may be referred to as a “positive term,” and the second term may be referred to as a “negative term,” due to the way the two terms are combined. The multi-term loss guides the four-step first image generation model towards the distribution of the pre-trained parent model by minimizing the divergence between the respective output distributions of the parent model and the first image generation model. The use of the multi-term loss provides an information-rich learning vector for training the four-step first image generation model.

Accordingly, embodiments of the present disclosure are configured to perform a fast mode and an upscaling operation for generating an image based on input text. In some cases, by performing a fast mode of image generation, embodiments of the present disclosure are able to provide for a user to quickly iterate on prompts and settings resulting in quicker ideation. In some cases, the image generation model of the present disclosure uses few iterations and reduces processes (e.g., does not perform certain processes) that are not required for generation of the low-resolution image. Additionally, embodiments of the present disclosure are configured to combine the fast mode workflow operation with image generation history to further improve the iteration process.

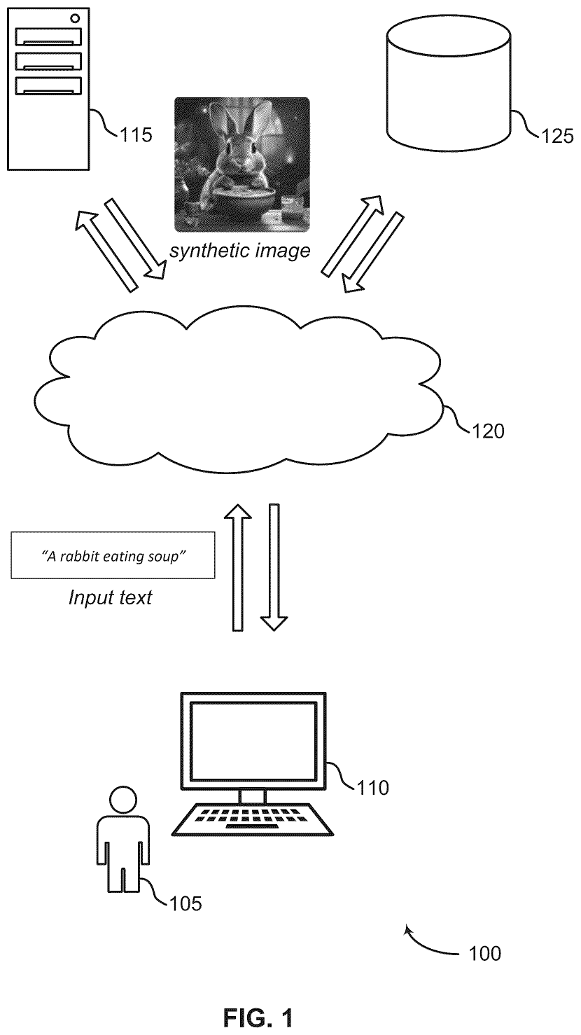

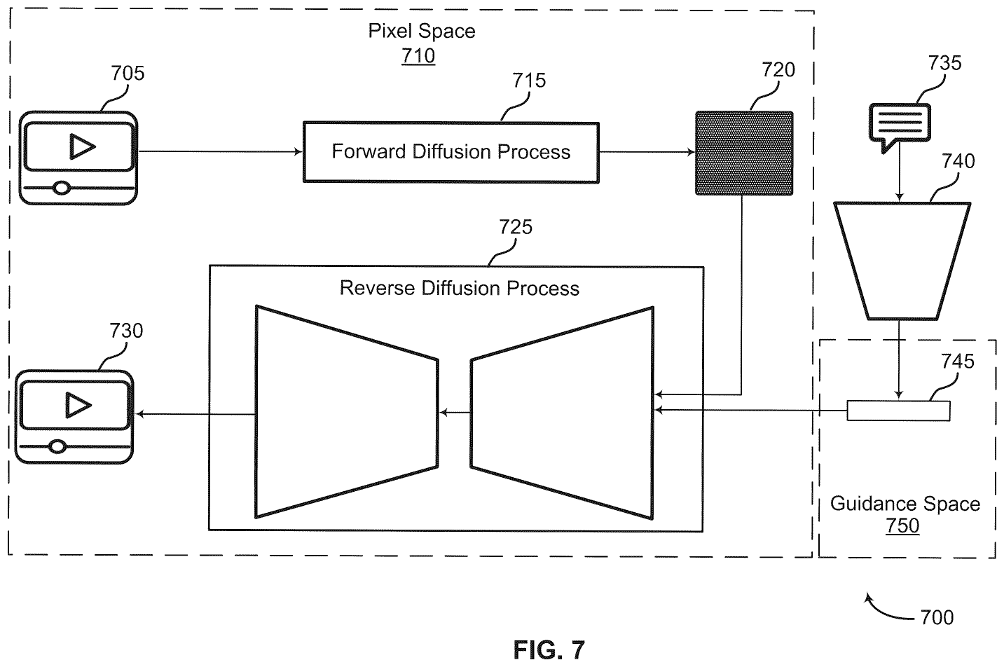

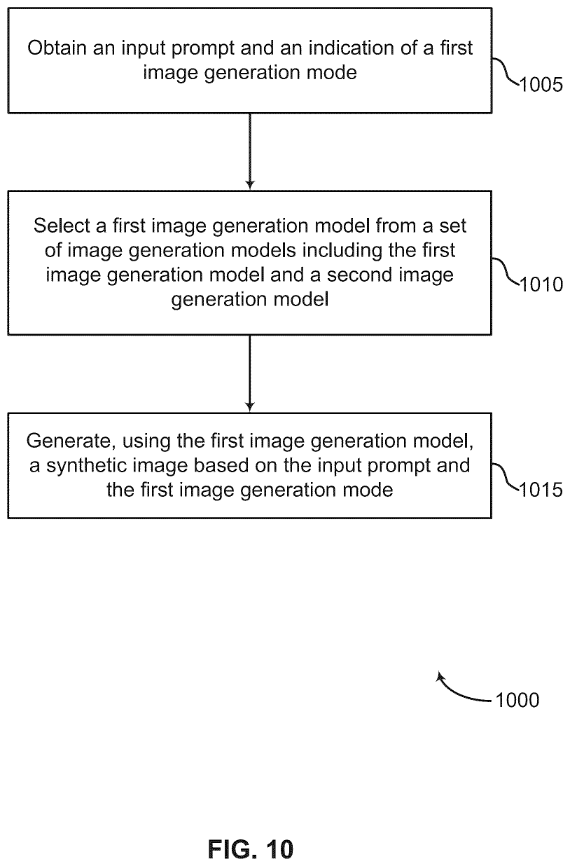

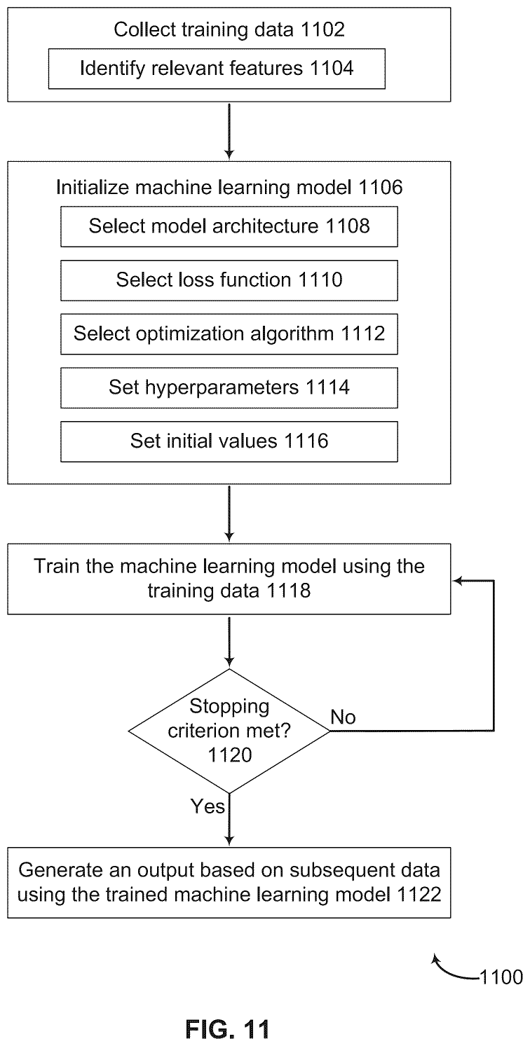

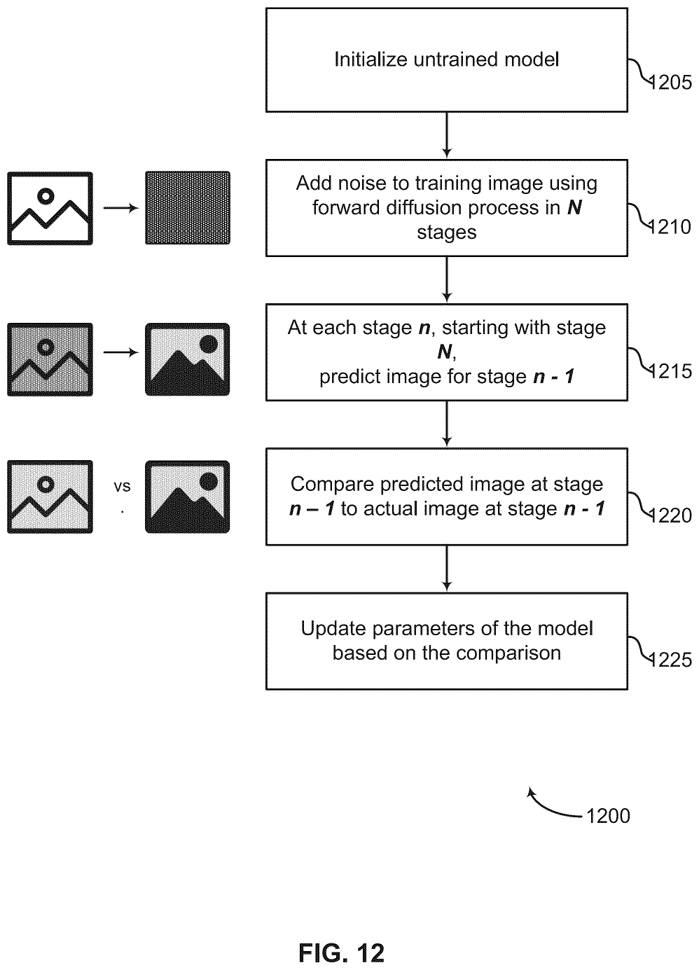

Embodiments of the present disclosure can be implemented in an image generation model. For example, the image generation model based on the present disclosure takes an input prompt (e.g., describing a scene) and quickly and accurately generates a low-resolution image depicting the input prompt and subsequently upscales the low-resolution image to generate a high-resolution image. Example applications regarding generating a synthetic image that depicts the prompt are provided with reference to FIGS. 1-6. Details regarding the architecture of the image generation model are provided with reference to FIGS. 7-9 and 13-16. Details regarding a process of operation of the image generation model are provided with reference to FIG. 10. Examples of a process for training the image generation model are provided with reference to FIGS. 11-12.

### Image Generation System

A system and an apparatus for image processing are described with reference to FIGS. 1-9. FIG. 1 shows an example of an image processing system 100 according to aspects of the present disclosure. In one aspect, an image processing system 100 includes user 105, user device 110, image processing apparatus 115, cloud 120, and database 125.

In the example of FIG. 1, user 105 provides an input prompt describing a scene to image processing apparatus 115 via a user interface provided on user device 110 by image processing apparatus 115. In some cases, the input prompt is an input text. As used herein, the input text indicates a scene that the user wants to depict in a generated output. According to some aspects, image processing apparatus 115 obtains the input prompt from the user, e.g., “A rabbit eating soup”.

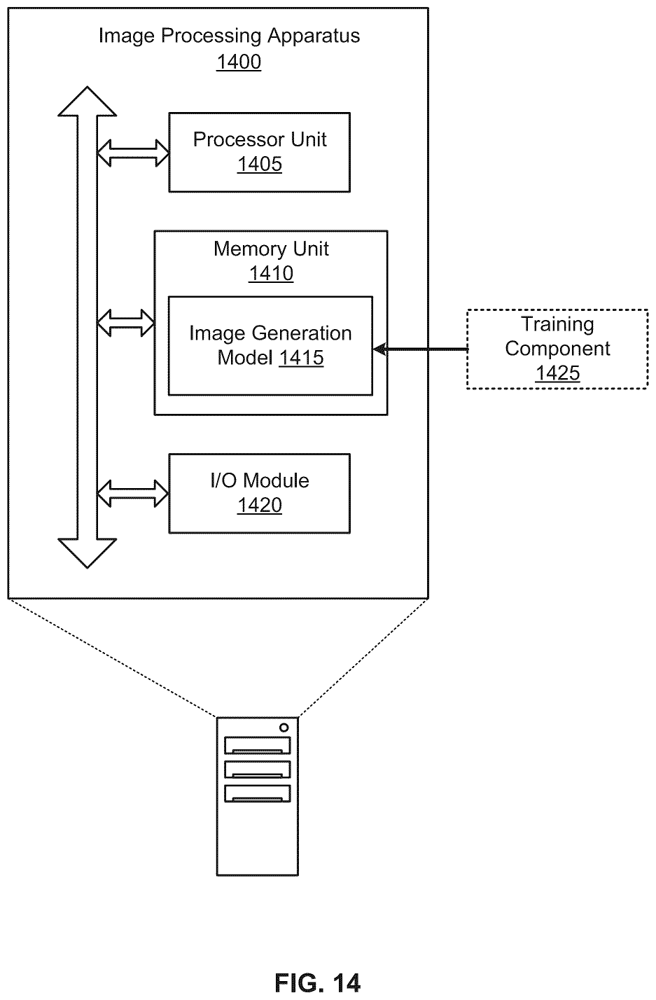

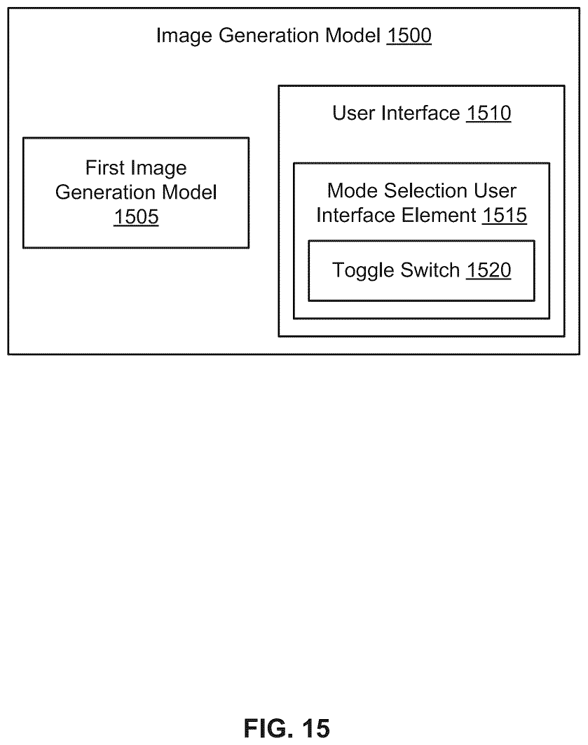

In some cases, the image processing apparatus 115 implements an image generation model (such as the image generation model described with reference to FIGS. 14-15) to quickly generate a synthetic image based on the input prompt. In some cases, as shown in FIG. 1, the user provides an input prompt (e.g., a text prompt) to the image processing apparatus 115, aspects of which the user wants to depict in the synthetic image. In some examples, the image processing apparatus quickly (e.g., in ˜1-2 seconds) and accurately generates an image to match the description provided by the input prompt. For example, as shown in FIG. 1, the image processing apparatus generates an output (i.e., a synthetic image) that depicts the scene described in the input prompt.

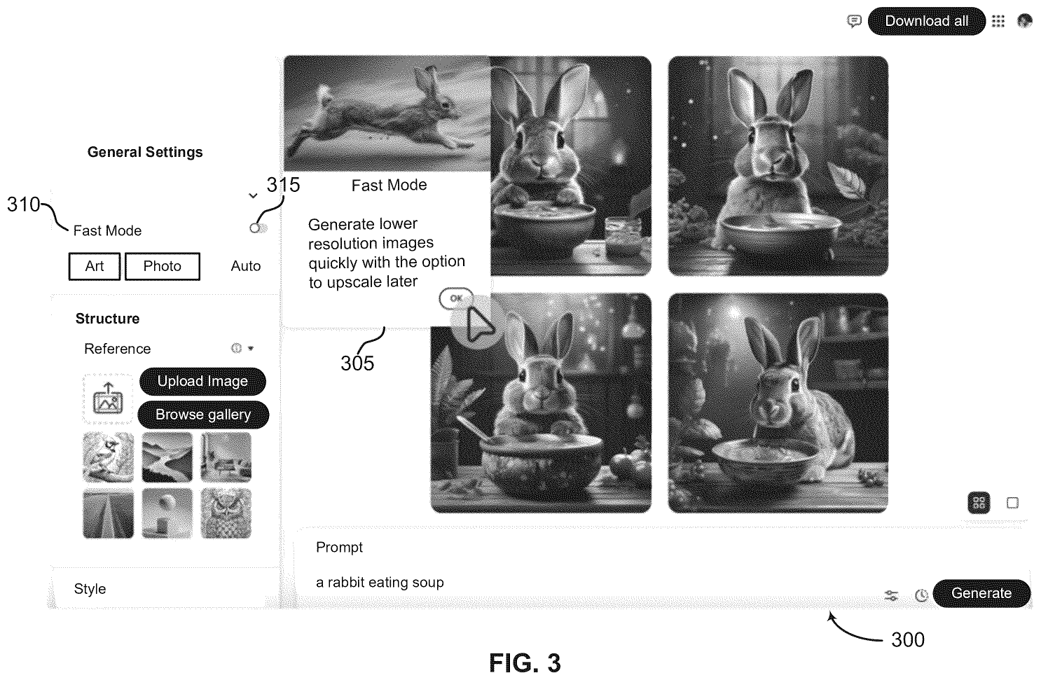

Referring to the example of FIG. 1, the image processing apparatus 115 provides the synthetic image to user 105 via the user interface provided on user device 110. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by image processing apparatus 115. In some aspects, the user interface provides for information (such as images (custom images or synthetic image), a prompt, etc.) to be communicated between user 105 and image processing apparatus 115. Image processing apparatus 115 is an example of, or includes aspects of, the corresponding element described with reference to FIGS. 3-6 and 14.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

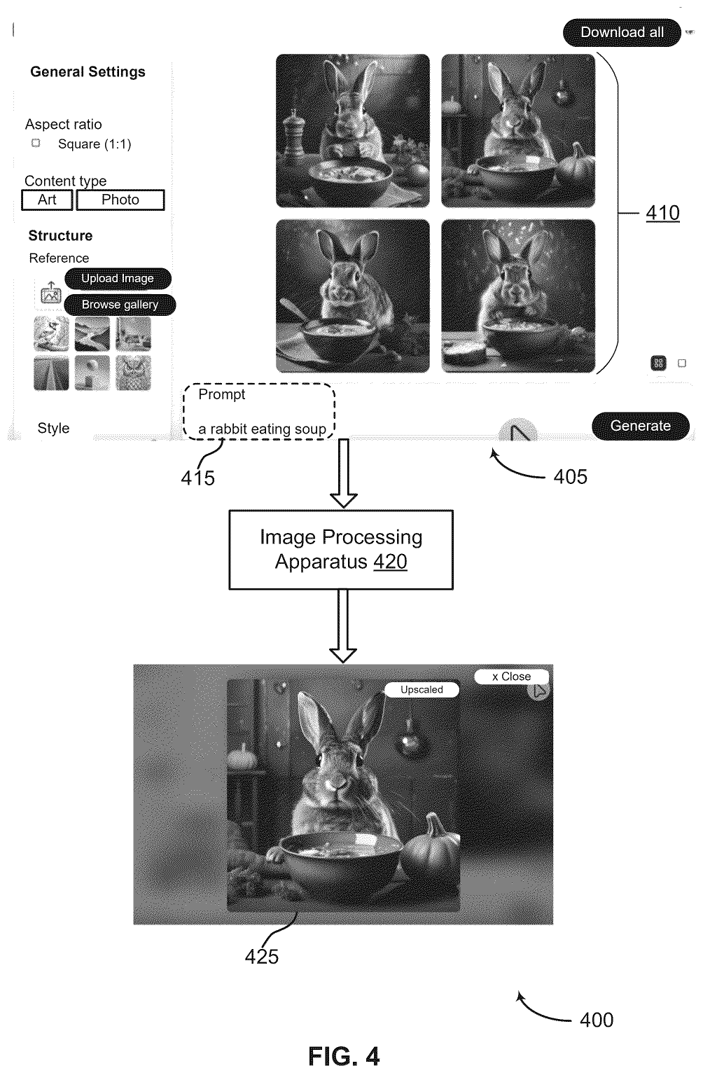

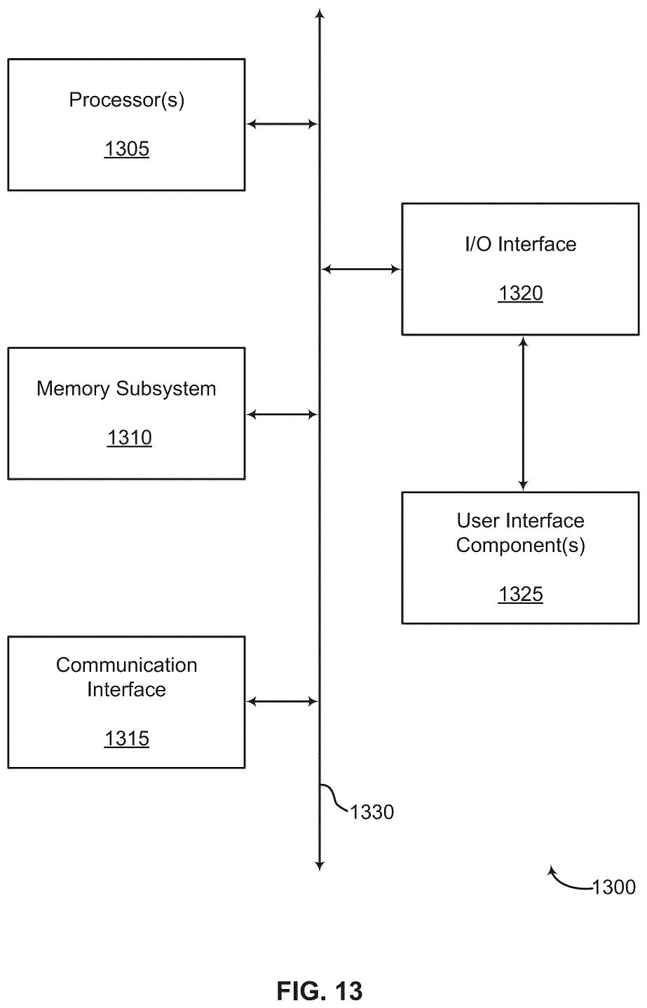

According to some aspects, image processing apparatus 115 includes a computer-implemented network. In some embodiments, the computer-implemented network includes a machine learning model (such as the machine learning model described with reference to FIGS. 4-8). In some embodiments, image processing apparatus 115 also includes one or more processors, a memory subsystem, a communication interface, an I/O interface, one or more user interface components, and a bus as described with reference to FIG. 13. Additionally, in some embodiments, image processing apparatus 115 communicates with user device 110 and database 125 via cloud 120.

In some cases, image processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, image processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to image processing apparatus 115 and communicates with image processing apparatus 115 via cloud 120. According to some aspects, database 125 is included in image processing apparatus 115.

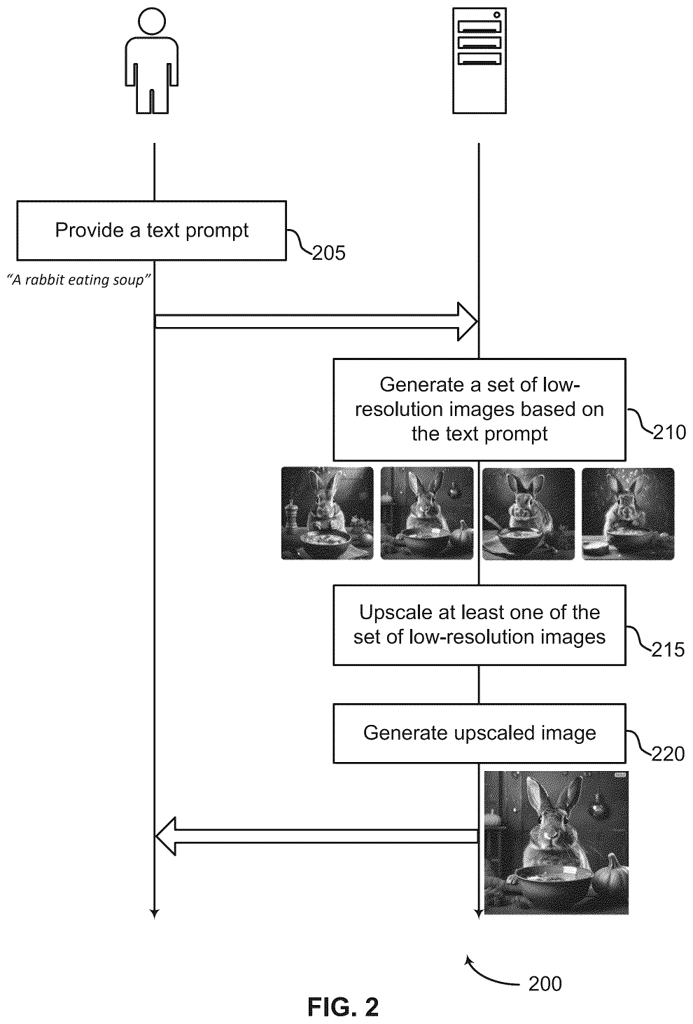

FIG. 2 shows an example of a method 200 for generating an image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

According to an embodiment of the present disclosure, an image processing apparatus (such as the image processing apparatus described with reference to FIG. 14) provides a machine learning model (such as the image generation model described with reference to FIGS. 14-15) that accurately generates a synthetic image depicting the scene described in the input text prompt in a fast mode (e.g., in 2-3 seconds).

At operation 205, the system provides a text prompt. In some cases, the operations of this step refer to, or may be performed by, a user as described with reference to FIG. 1.

In some examples, the user provides a text prompt to the image processing apparatus (such as the image processing apparatus described with reference to FIG. 1). As shown in FIG. 2, the text prompt describes a scene that the user wants to depict in the synthetic image. For example, the user wants the generated image (i.e., synthetic image) to depict “A rabbit eating soup” as specified in the text prompt. In some cases, the user provides the text prompt to the image processing apparatus via a user interface (such as a graphical user interface) provided on a user device by the image processing apparatus.

At operation 210, the system generates a set of low-resolution images based on the text prompt. In some cases, the operations of this step refer to, or may be performed by, an image processing apparatus as described with reference to FIGS. 1 and 14. In some cases, the image processing apparatus implements a four-step diffusion network (such as the diffusion network described with reference to FIGS. 7-9) with distribution matching distillation (DMD). Further details regarding this operation are provided with reference to at least FIGS. 7-10.

According to an embodiment, the image processing apparatus comprising an image generation model based on the four-step diffusion process with DMD may be configured to generate an image based on a fast mode. In some cases, the generated image is a low-resolution image with less details. For instance, the generated image has a dimension of 512×512. In some cases, the image generation model provides for a user to iterate fast at a low-resolution and edit or enhance the prompts for quick ideation.

At operation 215, the system upscales at least one of the set of low-resolution images. In some cases, the operations of this step refer to, or may be performed by, an image processing apparatus as described with reference to FIG. 1.

In some cases, the image processing apparatus of the present disclosure is configured to perform an upscaling of at least one of the set of low-resolution images. For instance, upscaling of the low-resolution image is performed by clicking an upscale option provided on the low-resolution image. In some examples, the upscaled image includes enhanced details and a high-resolution of the low-resolution image. For instance, the upscaled image has a dimension of 2k×2k. Further details regarding the upscaling process are provided with reference to FIGS. 3-6 and 10.

At operation 220, the system generates the upscaled image. In some cases, the operations of this step refer to, or may be performed by, an image processing apparatus as described with reference to FIG. 1.

Embodiments of the present disclosure are configured to generate a low-resolution synthetic image in a fast mode and an upscaled image (e.g., using processes described with reference to at least FIGS. 3-6). For example, the image processing apparatus is, thus, able to accurately generate a synthetic image by incorporating aspects of the input prompt (e.g., “A rabbit eating soup”). For example, in some cases, the image processing apparatus displays the synthetic image and the upscaled image to the user via the user interface (such as the user interface described with reference to FIGS. 1 and 3-6).

FIG. 3 shows an example of a user interface 300 according to aspects of the present disclosure.

According to an embodiment of the present disclosure, the image processing apparatus comprises an image generation model configured to perform image generation in different modes. In some cases, a fast mode enables generation of images that include a dimension of 512×512 in about 2-3 seconds. In some cases, an upscaling of the generated image may be performed resulting in a full resolution image of 2k×2k resolution in about 7-8 seconds.

In some cases, the image generation process may be classified as a generation step, an upscaling step, and a downloading/sharing step. In some cases, a user is able to download at least one of the set of low-resolution images using a download option on the low-resolution image in the user interface. Additionally or alternatively, the user is able to download the full resolution image (i.e., a high-resolution image generated based on the low-resolution image) using a download option on the high-resolution image in the user interface. In some cases, embodiments of the present disclosure are configured to provide for a fast image generation (i.e., generating low-resolution image) for quick ideation and for an upscale option for generation of high-resolution image.

Embodiments of the present disclosure are configured to provide a user interface for generating a synthetic image and an upscale image. As shown in FIG. 3, the user interface 300 enables a user to interact with the workflow while providing an option to upscale to high resolution. In one aspect, user interface 300 includes mode selection coachmark 305, mode selection user interface element 310, and first image generation mode 320. User interface 300 is an example of, or includes aspects of, the corresponding element described with reference to FIGS. 4-6, and 15.

Referring to FIG. 3, the user interface 300 depicts the mode selection user interface element 310 with fast mode selected. In some aspects, the mode selection user interface element 310 includes a toggle switch 315 for switching between the first image generation mode 320 and the second image generation mode (e.g., a normal mode). For example, as shown in FIG. 3, the toggle switch 315 is placed outside the model card drop down list. Mode selection user interface element 310 is an example of, or includes aspects of, the corresponding element described with reference to FIG. 15. Toggle switch 315 is an example of, or includes aspects of, the corresponding element described with reference to FIG. 15.

In case of a first visit of the user, user interface 300 displays mode selection mark 305 for announcing an update or providing a brief explanation on the fast mode (i.e., first image generation mode). On clicking ‘OK’ in the mode selection mark 305, the user is able to perform image generation (i.e., image generation of low-resolution synthetic images and high-resolution upscaled images).

FIG. 4 shows an example of a process in a first image generation mode according to aspects of the present disclosure. In one aspect, image generation process 400 includes user interface 405, image processing apparatus 420, and upscaled image 425.

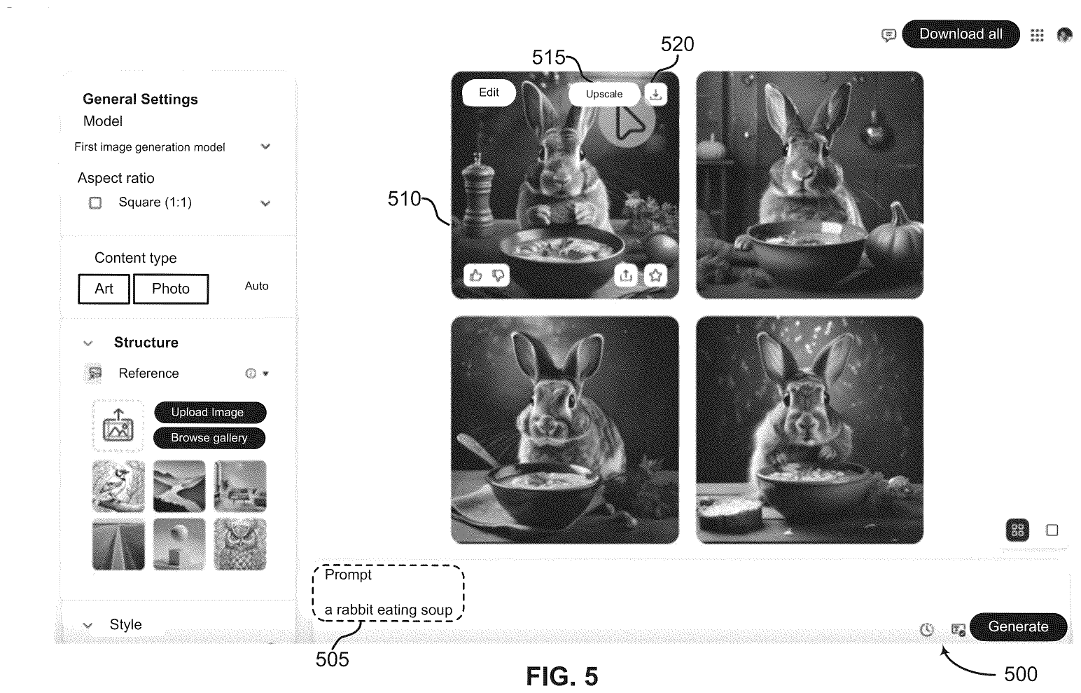

Referring to FIG. 4, user interface 405 depicts a process of image generation in the first image generation mode (i.e., fast mode). In one aspect, user interface 405 includes synthetic image 410 and input prompt 415. In some cases, user enters input prompt 415 via user interface 405 and the first image generation model (such as the first image generation model described with reference to FIG. 10 and the first image generation model 1505 described with reference to FIG. 15) generates a set of synthetic images 410. For instance, the set of synthetic images 410 are low-resolution images. User interface 405 is an example of, or includes aspects of, the corresponding element described with reference to FIGS. 3, 5, 6, and 15. Synthetic image 410 is an example of, or includes aspects of, the corresponding element described with reference to FIG. 5. Input prompt 415 is an example of, or includes aspects of, the corresponding element described with reference to FIG. 5.

In some cases, the user wants to upscale at least one of the set of synthetic images 410 in user interface 405. For example, the user wants to generate a high-resolution image using the upscaling operation. In some examples, the upscaling operation is initiated by the user by clicking an ‘Upscale’ option (such as upscale option 515 described with reference to FIG. 5) on the synthetic image. In some examples, the upscaling operation is performed in approximately 7-8 seconds.

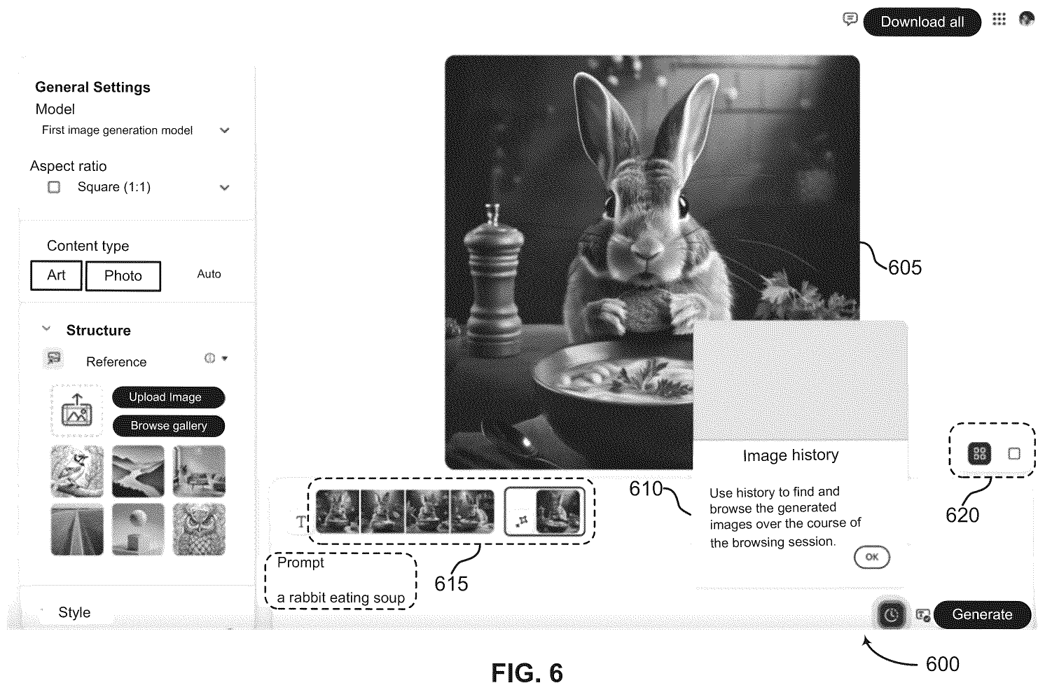

The image processing apparatus 420 (such as the image processing apparatus described with reference to FIGS. 1-2 and 14) of the present disclosure receives the at least one of the set of synthetic images 410. In some cases, the image processing apparatus 420 performs a diffusion operation on the received synthetic image to generate upscaled image 425. In some cases, the upscaled image 425 is a high-resolution image based on a corresponding synthetic image 410 and matches aspects of the input prompt 415. For instance, the image processing apparatus 420 generates a high-resolution image that depicts “A rabbit eating soup” based on the input prompt 415. Image processing apparatus 420 is an example of, or includes aspects of, the corresponding element described with reference to FIG. 14. Upscaled image 425 is an example of, or includes aspects of, the corresponding element described with reference to FIG. 6.

FIG. 5 shows an example of upscaling a synthetic image 510 according to aspects of the present disclosure.

As described with reference to FIGS. 2-4, the image processing apparatus (such as the image processing apparatus described with reference to at least FIGS. 1, 3, and 15) generates a set of synthetic images based on input prompt provided via user interface. For example, the image processing apparatus displays a set of synthetic images (such as synthetic image 510) in user interface 500. In some examples, the synthetic image 510 is generated based on input prompt 505 received via user interface 500. For example, the set of synthetic images (such as synthetic image 510) is generated in 2-3 seconds and each synthetic image of the set of synthetic images has a resolution of 512×512.

User interface 500 is an example of, or includes aspects of, the corresponding element described with reference to FIGS. 3, 4, 6, and 15. In one aspect, user interface 500 includes input prompt 505 and synthetic image 510. Input prompt 505 is an example of, or includes aspects of, the corresponding element described with reference to FIG. 4. Synthetic image 510 is an example of, or includes aspects of, the corresponding element described with reference to FIG. 4.

In some cases, when a user hovers over any of the generated synthetic images, the user sees an upscale option and a download option. For example, as shown in FIG. 5, when the user hovers over synthetic image 510, the synthetic image 510 depicts upscale option 515 and download option 520. In some examples, the upscale option additionally shows a coachmark for first time users. In some cases, the upscale coachmark defines the upscaling process. For example, the upscale coachmark indicates that the upscaling process generates a high-resolution 2k×2k image.

In some cases, when a user clicks on the upscale option 515, a high-resolution image (such as upscaled image 425 described with reference to FIG. 4) is generated based on the same synthetic image. After completion of the upscale process, the high-resolution image indicates a label (e.g., a label “Upscaled” which indicates that the synthetic image has been upscaled or converted to a high-resolution image). After completion of the upscale process, the upscale option (such as upscale option 515) is disabled in the upscaled image.

Additionally, after completion of the upscale process, the synthetic image indicates a label (e.g., a label “Upscaled” which indicates that the synthetic image has been upscaled or converted to a high-resolution image). After completion of the upscale process, the upscale option (such as upscale option 515) is disabled in the synthetic image. In some cases, each of the synthetic image 510 and upscaled image can be downloaded by the user using download option 520 and a download option in the upscaled image, respectively.

FIG. 6 shows an example of an image generation history according to aspects of the present disclosure.

Embodiments of the present disclosure are configured to combine an image generation session history with the user interface (such as user interface described with reference to FIGS. 3-5 and 13-15). User interface 600 is an example of, or includes aspects of, the corresponding element described with reference to FIGS. 3-5 and 15. In one aspect, user interface 600 includes upscaled image 605, image history coachmark 610, image history result 615, and view option 620. Upscaled image 605 is an example of, or includes aspects of, the corresponding element described with reference to FIG. 4.

According to an exemplary embodiment of the present disclosure, user interface 600 is configured to depict the set of synthetic images (such as synthetic images described with reference to FIGS. 3-5). Additionally, as shown in FIG. 6, user interface depicts the upscaled image 605 in a carousal view. In some cases, when the image is upscaled, the user interface 600 depicts image history result 615 along with the upscaled image 605.

In some cases, when the user is a first-time user, the image history result 615 is expanded (as depicted in FIG. 6). Additionally, in case of first-time users, image history coachmark 610 is provided after upscaling at least one synthetic image of the set of synthetic images (such as synthetic images described with reference to FIGS. 3-5). In some cases, the image history coachmark 610 is used to describe the image history, i.e., image history coachmark 610 states that image history result 615 is used to find and browse the generated images over the course of a browser session.

In some cases, when a user clicks on the image history result 615, the user is able to see the previous image generation results. Accordingly, by providing an option for viewing the image history result at the user interface, embodiments of the present disclosure are able to enable a user to compare the image generation results. Additionally, based on comparing the current image generation results with the previous image generation results, embodiments of the present disclosure provide for the user to create a clear separation between the set of synthetic images (low-resolution) and upscaled images (high-resolution).

According to an embodiment of the present disclosure, an image viewing option within the user interface remain same. For instance, a user clicks on the view option 620 to see the upscaled image 605 in a carousal view. In some examples, the images are saved using the lightbox experience. Accordingly, image history result 615 is incorporated into the user interface 600 (using fast mode or first image generation mode) for an improved experience and an ease of the user.

An exemplary embodiment of the present disclosure is configured to provide a user interface including a linear grid view. For instance, the linear grid view of the user interface differs from the user interface (such as the user interface described with reference to FIGS. 3-5) in the arrangement of the set of synthetic images (such as the set of synthetic images described with reference to FIGS. 3-5).

According to an embodiment, the image history result or an image generation result is arranged chronologically in the linear grid view. For instance, each of the set of synthetic images generated in a user session is arranged chronologically (e.g., new generation results above a previous generation result in a user interface) and associated with a corresponding input prompt (such as input prompt described with reference to at least FIG. 1). In some cases, each of the set of synthetic images include additional options such as remixing, downloading, etc.

Additionally, each of the chronologically arranged images include an option for upscaling and downloading the synthetic image (such as synthetic image including upscaling and downloading options described with reference to FIGS. 3-5). Additionally, when a user hovers over the generated image, the user is able to identify an image that the user liked and/or upscaled to continue to iterate based on the previous image generation.

In some cases, in case of the carousal view, the image history is displayed as a film strip (such as shown in FIG. 6), where each chronologically arranged set of synthetic images are classified as an image generation group. In some cases, the user is able to switch the image generation group and see different upscaled (i.e., high-resolution) images corresponding to the image generation group. In some cases, the user can hide the image generation history using a prompt bar in the user interface.

FIG. 7 shows an example of a guided diffusion model 700 according to aspects of the present disclosure. In some examples, guided diffusion model 700 describes the operation and architecture of the image generation model 1415 described with reference to FIG. 14 or image generation model 1500 described with reference to FIG. 15. The guided latent diffusion model 700 depicted in FIG. 7 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 700 may take an original media item 705 in a pixel space 710 as input and apply forward diffusion process 715 to gradually add noise to the original media item 705 to obtain noisy media item 720 at various noise levels.

Next, a reverse diffusion process 725 (e.g., a U-Net) gradually removes the noise from the noisy media item 720 at the various noise levels to obtain an output media item 730. In some cases, an output media item 730 is created from each of the various noise levels. The output media item 730 can be compared to the original media item 705 to train the reverse diffusion process 725.

The reverse diffusion process 725 can also be guided based on a text prompt 735, or another guidance prompt, such as an image, a layout, a segmentation map, etc. The text prompt 735 can be encoded using a text encoder 765 (e.g., a multimodal encoder) to obtain guidance features 745 in guidance space 750. The guidance features 745 can be combined with the noisy media item 720 at one or more layers of the reverse diffusion process 725 to ensure that the output media item 730 includes content described by the text prompt 735. For example, guidance features 745 can be combined with the noisy features using a cross-attention block within the reverse diffusion process 725.

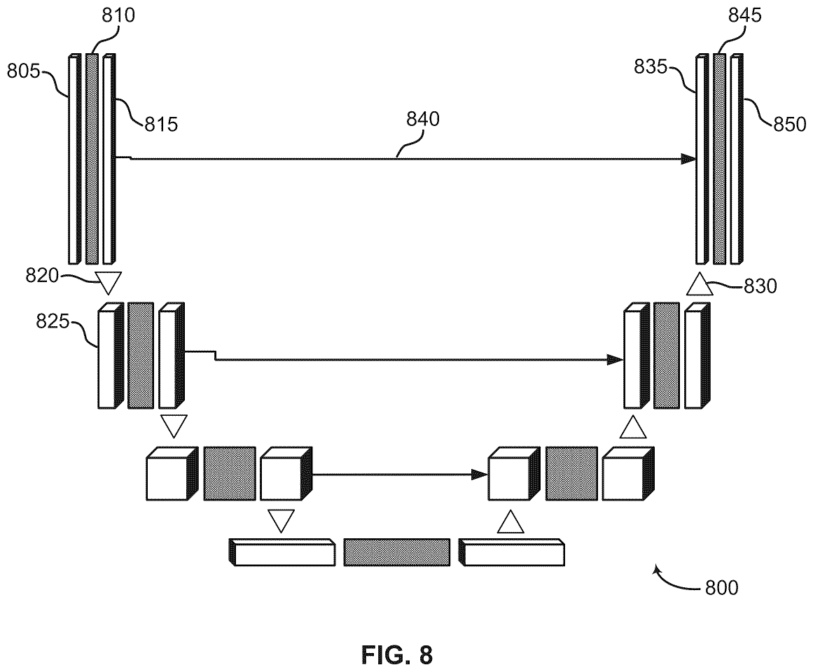

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item. DDIM is an example of, or includes aspects of, the corresponding element described with reference to FIGS. 8-10 and 11-14.

FIG. 8 shows an example of a U-Net 800 according to aspects of the present disclosure. In some examples, U-Net 800 is an example of the component that performs the reverse diffusion process 725 of guided diffusion model 700 described with reference to FIG. 7 and includes architectural elements of the image generation model 1415 described with reference to FIG. 14 or image generation model 1500 described with reference to FIG. 15. The U-Net 800 depicted in FIG. 8 is an example of, or includes aspects of, the architecture used within the reverse diffusion process described with reference to FIG. 7.

In some examples, diffusion models are based on a neural network architecture known as a U-Net. The U-Net 800 takes input features 805 having an initial resolution and an initial number of channels and processes the input features 805 using an initial neural network layer 810 (e.g., a convolutional network layer) to produce intermediate features 815. The intermediate features 815 are then down-sampled using a down-sampling layer 820 such that down-sampled features 825 features have a resolution less than the initial resolution and a number of channels greater than the initial number of channels.

This process is repeated multiple times, and then the process is reversed. That is, the down-sampled features 825 are up-sampled using up-sampling process 830 to obtain up-sampled features 835. The up-sampled features 835 can be combined with intermediate features 815 having the same resolution and number of channels via a skip connection 840. These inputs are processed using a final neural network layer 845 to produce output features 850. In some cases, the output features 850 have the same resolution as the initial resolution and the same number of channels as the initial number of channels.

In some cases, U-Net 800 takes additional input features to produce conditionally generated output. For example, the additional input features could include a vector representation of an input prompt. The additional input features can be combined with the intermediate features 815 within the neural network at one or more layers. For example, a cross-attention module can be used to combine the additional input features and the intermediate features 815. U-Net architecture is an example of, or includes aspects of, the corresponding element described with reference to FIGS. 7 and 9-14.

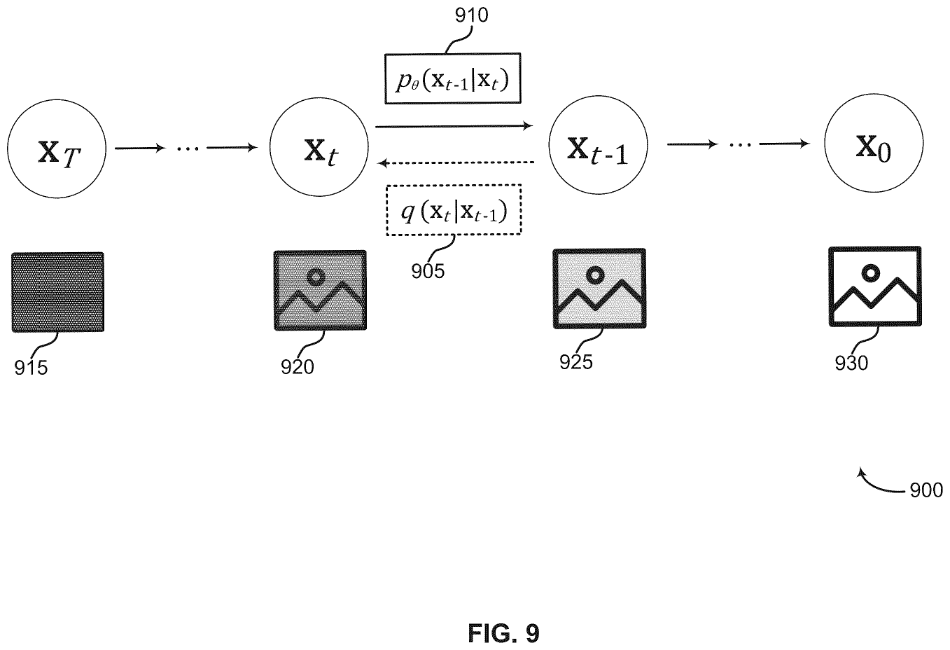

FIG. 9 shows a diffusion process 900 according to aspects of the present disclosure. In some examples, diffusion process 900 describes an operation of the image generation model 1415 described with reference to FIG. 14 or image generation model 1500 described with reference to FIG. 15, such as the reverse diffusion process 725 of guided diffusion model 700 described with reference to FIG. 7.

As described above with reference to FIG. 7, using a diffusion model can involve both a forward diffusion process 905 for adding noise to a media item (or features in a latent space) and a reverse diffusion process 910 for denoising the media item (or features) to obtain a denoised media item. The forward diffusion process 905 can be represented as q(xₜ|xₜ₋₁), and the reverse diffusion process 910 can be represented as p(xₜ₋₁|xₜ). In some cases, the forward diffusion process 905 is used during training to generate media items with successively greater noise, and a neural network is trained to perform the reverse diffusion process 910 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 910, the model begins with noisy data X_{T}, such as a noisy media item 915 and denoises the data to obtain the p(xₜ₋₁|xₜ). At each step t−1, the reverse diffusion process 910 takes xₜ, such as first intermediate media item 920, and t as input. Here, t represents a step in the sequence of transitions associated with different noise levels, The reverse diffusion process 910 outputs xₜ₋₁, such as second intermediate media item 925 iteratively until x_{T} reverts back to x₀, the original media item 930. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 1 )$$

The joint probability of a sequence of samples in the Markov chain can be written as a product of conditionals and the marginal probability:

$${x}_{t} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 2 )$$

where p(x_{T})=N(x_{T}; 0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality. Diffusion process is an example of, or includes aspects of, the corresponding element described with reference to FIGS. 7, 8, and 10-14.

### Image Generation Process

The present disclosure describes systems and methods for image generation. Embodiments of the present disclosure include a user interface configured to provide for a user to perform image generation based on a first mode or a second mode. In some cases, the first mode for image generation refers to a fast mode and the second mode for image generation refers to a normal mode.

According to an embodiment of the present disclosure, the user provides a prompt (e.g., a text prompt) indicating an element the user wants to depict in a synthetic image. For instance, the user provides the prompt to the user interface (such as the user interface described with reference to FIGS. 3-5) provided on a user device. Additionally, the user interface provides for the user to select an option for enabling the first image generation mode (e.g., fast mode).

Embodiments of the present disclosure include an image generation model comprising a diffusion network. In some cases, the diffusion network is distilled during the generative reverse diffusion process to four-steps and the parameters of the diffusion network are updated based on the distillation results. Accordingly, by using a distilled diffusion network, embodiments of the present disclosure are able to quickly and accurately generate an image based on the prompt (e.g., text prompt provided by the user via the user interface of the user device).

In some cases, the user interface is configured to display a set of synthetic images (such as the set of synthetic images described with reference to FIGS. 3-6) generated by the image generation model based on the prompt. For example, the set of synthetic images are low-resolution images that are generated within 2-3 seconds. Additionally, the user interface provides for a user to upscale at least one of the synthetic images using the image generation model. In some examples, each synthetic image of the set of synthetic images depicts an option to upscale the low-resolution synthetic image. For example, the upscaled image (such as the upscaled image described with reference to FIGS. 3-6) is a high-resolution image that depicts the same content as the corresponding synthetic image. In some examples, the upscaled image is displayed in the user interface of the user device and is generated within 7-8 seconds.

FIG. 10 shows an example of a method 1000 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1005, the system obtains an input prompt and an indication of a first image generation mode. In some cases, the operations of this step refer to, or may be performed by, a user interface as described with reference to FIGS. 3-6, and 15.

For example, in some cases, the user interface of the image processing apparatus (such as image processing apparatus 1400 described with reference to FIG. 14) receives an input prompt from a user. In some examples, the input prompt describes a scene. Additionally, the user selects a first image generation mode via the user interface of the image processing apparatus. In some examples, the first image generation mode indicates a fast mode.

At operation 1010, the system selects a first image generation model from a set of image generation models including the first image generation model and a second image generation model, where the first image generation model corresponds to the first image generation mode and the second image generation model corresponds to the second image generation mode different from the first image generation mode. In some cases, the operations of this step refer to, or may be performed by, a user interface as described with reference to FIGS. 3-6, and 15.

In some cases, the user interface of the image processing apparatus selects the first image generation model based on the selection of the fast mode by the user (as described with reference to operation 1005). In some cases, the first image generation model comprises a modified diffusion network. For example, the diffusion network is distilled during the generative reverse diffusion process to four-steps and the parameters of the diffusion network are updated based on the distillation results.

In some examples, a first image generation model is selected from among a first image generation model and a second image generation model, wherein the first image generation model comprises a compressed student model trained to match an output distribution of the second image generation model using the second generation model as a teacher model. For example, the first image generation model may be a smaller model or a faster model trained using Distribution Matching Distillation (DMD). Thus, the user may select between a fast generation mode and a high-quality or high-resolution generation mode corresponding the different image generation models.

DMD is a variant of knowledge distillation that focuses on aligning the output distributions of the student and teacher models rather than simply matching specific predictions. The DMD method emphasizes aligning the student's probability distribution over classes with that of the teacher model to capture nuanced patterns in the data, thereby enhancing the student's ability to generalize.

In some cases, the DMD encourages the student model to generate output probabilities that resemble the teacher's distribution over different classes which enables the student capture the teacher's knowledge more comprehensively, beyond correct classifications. Additionally, the DMD implements a loss function such as Kullback-Leibler (KL) divergence to measure the similarity between the output distributions of the teacher and student. The KL divergence penalizes the difference between the two distributions, guiding the student to replicate the teacher's knowledge structure more precisely. In some cases, the DMD uses “soft labels” via temperature scaling. By adjusting the temperature, the smoothness of the distribution is controlled which provides for the student to learn from subtle relationships between classes that may be lost with hard labels.

Embodiments of the present disclosure include the first image generation model capable of performing fast and accurate four-step image generation. In some cases, the stable, four-step transformation is performed through a training method based on a distribution-matching loss, which guides the first image generation model to produce images in the same distribution as a pre-trained, multi-step parent generation model. The distribution-matching approach (i.e., DMD) leads to more stable outputs, even when the model is given complex guidance features such as from text prompts.

In some cases, the distribution-matching loss includes a first term from the parent model, and a second term from an unlocked and jointly-trained model. As used herein, the first term may be referred to as a “positive term,” and the second term may be referred to as a “negative term,” due to the way the two terms are combined. This multi-term loss guides the four-step image generation model towards the distribution of the pre-trained model by minimizing the divergence between their respective output distributions. The use of the multi-term loss provides an information-rich learning vector for training the four-step generation model.

The first image generation model retains high-quality, realistic generation ability even when used for text-to-image generation. Accordingly, embodiments of the present disclosure are able to improve on conventional image generation models in speed and accuracy by enabling the generation of condition-aligned, high quality, and diverse images in four-steps, thereby providing flexibility of trading multiple steps for better image quality, greatly reducing the inference time, and providing for real-time user interaction.

In some cases, a training process is configured to distill a pre-trained diffusion denoiser, pre-trained model, i.e., a parent network, into a fast four-step image generator. The four-step image generator, image generation model, is trained to produce high-quality images within the same distribution as the base model, but without multi-step iteration procedure.

As described with reference to FIGS. 7-9, a diffusion model is trained to reverse a Gaussian diffusion process that progressively adds noise to a sample from a real data distribution to turn it into white noise over the time steps. According to some aspects, a pre-trained model is used to generate training data by starting from a training noise input to produce training image output. In some examples, training is solely based on gradient term.

According to an embodiment, the four-step generator includes the same architecture as a base diffusion denoiser, e.g., a U-Net, but without the time-conditioning. In at least one embodiment, the parameters of the four-step generator are initialized to the parameters of the pre-trained diffusion denoiser. During training, embodiments minimize the Kullback-Liebler (KL) divergence between the “real” distribution produced by the pre-trained model and the “fake” distribution, whose score is provided by the jointly-trained model, calculated for outputs from the untrained four-step generator.

According to some aspects, the gradient term is computed as a combination of scores. The score is defined as the gradient of the log probability at each step of noise addition. The score guides the model in reversing the noise addition to regenerate the data. Multi-step diffusion models such as pre-trained model and jointly-trained model can be thought of as “score functions” that are configured to produce scores of the real and fake distributions for the denoising process using the output of four-step generator.

In some cases, the first image generation model is trained based on a multi-term loss including a first term based on an output of a pre-trained model, and a second term based on an output of a jointly-trained model, where the first term is added to the multi-term loss and the second term is subtracted from the multi-term loss. “Single pass” refers to a single generative iteration, standing in contrast with other generators which use multiple iterations to remove noise from a starting sample. The pre-trained model is a multi-step model and is considered a “parent” model. The first term represents a directional change towards the distribution of the parent model. The parent model's parameters are locked, and the model therefore retains its knowledge of realistic images acquired during pre-training throughout the training process of the image generation model.

By contrast, the jointly-trained model has unlocked parameters. Throughout the training of the four-step image generation model, the jointly-trained model learns to approximate the outputs from the latest version of the four-step image generation model. The output, the “second term,” represents a directional change towards its less-than-realistic distribution, sometimes referred to herein as a “fake” distribution. Therefore, the second term is subtracted from the first term to form a combined direction, the multi-term loss, that simultaneously guides the four-step image generation model towards the distribution of the parent model and away from the distribution of the jointly-trained model.

Accordingly, by implementing DMD comprising a student model that captures the probability distribution rather than only final predictions, embodiments of the present disclosure are able to have improved generalization to unseen data. Additionally, since the student model incorporates the knowledge distribution of the teacher (e.g., including uncertainty or relationships between classes), DMD is implemented when inter-class relationships are used. The first image generation model incorporates the DMD method which enables comprehensive knowledge transfer from a large model to maintain performance despite size or computational constraints, such as when deploying on resource-limited devices.

Accordingly, an embodiment of the present disclosure is configured to approximate the gradient term by combining the scores on the noise-added outputs from the four-step generator and take the expectation over the diffusion time steps. According to an embodiment, a time-dependent scalar weight is computed to normalize the gradient term's magnitude across different noise levels. Additionally, in some cases, a regression loss is computed. According to an embodiment, the regularization loss can prevent issues during training such as mode collapse or mode dropping, in which the fake distribution assigns a higher overall density to a subset of the modes.

Accordingly, embodiments of the present disclosure are able to train a four-step generator to match the output distribution of a multi-step, pre-trained parent network. According to some embodiments of the present disclosure, a training component is used for computing the various loss functions (e.g., regression loss, diffusion loss, etc.) by manipulating the output of the four-step generator and the score functions. The first image generation model comprising the four-step generator is then used to generate the synthetic image in a fast mode. Additionally, the first image generation model is used to upscale the synthetic image to generate an upscaled image.

Accordingly, at operation 1015, the system generates, using the first image generation model, a synthetic image based on the input prompt. In some cases, the operations of this step refer to, or may be performed by, a first image generation model as described with reference to FIGS. 4 and 15. For example, the synthetic image is displayed to the user via the user interface of the image processing apparatus (as described with reference to FIGS. 3-5).

Therefore, a method for image processing is described. One or more aspects of the method include obtaining an input prompt and an indication of a first image generation mode; selecting a first image generation model from a set of image generation models including the first image generation model and a second image generation model, wherein the first image generation model corresponds to the first image generation mode and the second image generation model corresponds to the second image generation mode different from the first image generation mode; and generating, using the first image generation model, a synthetic image based on the input prompt.

Some examples of the method, apparatus, and non-transitory computer readable medium further include providing a mode selection user interface element. Some examples further include receiving the indication from a user via the mode selection user interface element. In some aspects, the first image generation mode comprises an accelerated image generation mode. In some aspects, the first image generation model comprises a distillation of the second image generation model.

Some examples of the method, apparatus, and non-transitory computer readable medium further include selecting a first image resolution for the synthetic image based on the indication of the first image generation mode, wherein the first image resolution corresponds to the first image generation mode and is different from a second image resolution that corresponds to the second image generation mode.

Some examples of the method, apparatus, and non-transitory computer readable medium further include upscaling the synthetic image from the first image resolution based on the first image generation mode. Some examples of the method, apparatus, and non-transitory computer readable medium further include generating a plurality of synthetic images including the synthetic image, wherein each of the plurality of synthetic images depicts a same image element from the input prompt. Some examples of the method, apparatus, and non-transitory computer readable medium further include obtaining a noise input. Some examples further include denoising the noise input based on the input prompt.

### Training

FIG. 11 shows an example of a method of training a machine learning model according to aspects of the present disclosure. FIG. 11 is a flow diagram depicting an algorithm as a step-by-step procedure 1100 in an example implementation of operations performable for training a machine-learning model. In some embodiments, the procedure 1100 describes an operation of the training component 1425 described for configuring the image generation model 1415 as described with reference to FIG. 14. The procedure 1100 provides one or more examples of generating training data, use of the training data to train a machine-learning model, and use of the trained machine-learning model to perform a task.

To begin in this example, a machine-learning system collects training data (block 1102) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1104) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1106). Initialization of the machine-learning model includes selecting a model architecture (block 1108) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1110). The loss function is utilized to measure a difference between an output of the machine-learning model (i.e., predictions) and target values (e.g., as expressed by the training data) to be used to train the machine-learning model. Additionally, an optimization algorithm is selected (1112) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1114) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1118) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1120), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1120), the procedure 1100 continues training of the machine-learning model using the training data (block 1118) in this example.

If the stopping criterion is met (“yes” from decision block 1120), the trained machine-learning model is then utilized to generate an output based on subsequent data (block 1122). The trained machine-learning model, for instance, is trained to perform a task as described above and therefore, once trained is configured to perform that task based on subsequent data received as an input and processed by the machine-learning model. The machine learning model is an example of, or includes aspects of, the corresponding element described with reference to FIGS. 7-10 and 12-15.

FIG. 12 shows an example of a method of training a diffusion model 1200 according to aspects of the present disclosure. In some embodiments, the method 1200 describes an operation of the training component 1425 described for configuring the image generation model 1415 as described with reference to FIG. 14. The method 1200 represents an example for training a reverse diffusion process as described above with reference to FIGS. 7-9. In some examples, these operations are performed by a system including a processor executing a set of codes to control functional elements of an apparatus, such as the guided diffusion model described in FIG. 7.

Additionally or alternatively, certain processes of method 1200 may be performed using special-purpose hardware. Generally, these operations are performed according to the methods and processes described in accordance with aspects of the present disclosure. In some cases, the operations described herein are composed of various substeps or are performed in conjunction with other operations.

Referring to FIG. 12, according to some aspects, a training component (such as the training component 1425 described with reference to FIG. 14) trains a diffusion model (such as the image generation model described with reference to FIGS. 7-10) to generate an output.

At operation 1205, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1210, the system adds noise to a training image (or an additional training image) using a forward diffusion process (such as the forward diffusion process described with reference to FIG. 7) in N stages. In some cases, the operations of this step refer to, or may be performed by, a training component as described with reference to FIG. 14.

At operation 1215, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1220, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1225, the system updates parameters of the model based on the comparison. For example, parameters of a U-Net may be updated using gradient descent. Time-dependent parameters of the Gaussian transitions can also be learned.

### Computing Device

FIG. 13 shows an example of a computing device according to aspects of the present disclosure. The computing device 1300 may be an example of the image processing apparatus 1400 described with reference to FIG. 14. In one aspect, computing device 1300 includes processor(s) 1305, memory subsystem 1310, communication interface 1315, I/O interface 1320, user interface component(s) 1325, and channel 1330.

In some embodiments, computing device 1300 is an example of, or includes aspects of, the image generation model of FIGS. 14-15. In some embodiments, computing device 1300 includes one or more processors 1305 that can execute instructions stored in memory subsystem 1310 to perform media generation.

According to some aspects, computing device 1300 includes one or more processors 1305. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1315 operates at a boundary between communicating entities (such as computing device 1300, one or more user devices, a cloud, and one or more databases) and channel 1330 and can record and process communications. In some cases, communication interface 1315 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1320 is controlled by an I/O controller to manage input and output signals for computing device 1300. In some cases, I/O interface 1320 manages peripherals not integrated into computing device 1300. In some cases, I/O interface 1320 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1320 or via hardware components controlled by the I/O controller.

According to some aspects, user interface component(s) 1325 enable a user to interact with computing device 1300. In some cases, user interface component(s) 1325 include an audio device, such as an external speaker system, an external display device such as a display screen, an input device (e.g., a remote-control device interfaced with a user interface directly or through the I/O controller), or a combination thereof. In some cases, user interface component(s) 1325 include a GUI.

FIG. 14 shows an example of an image processing apparatus 1400 according to aspects of the present disclosure. Image processing apparatus 1400 is an example of, or includes aspects of, the corresponding element described with reference to FIGS. 1 and 3. In one aspect, image processing apparatus 1400 includes processor unit 1405, memory unit 1410, I/O module 1420, and training component 1425. Training component 1425 updates parameters of the image generation model 1415 stored in memory unit 1410. In some examples, the training component 1425 is located outside the image processing apparatus 1400.

According to some aspects, processor unit 1405 comprises a processing device coupled to the memory component. Processor unit 1405 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1405 is configured to operate a memory array using a memory controller. In other cases, a memory controller is integrated into processor unit 1405. In some cases, processor unit 1405 is configured to execute computer-readable instructions stored in memory unit 1410 to perform various functions. In some aspects, processor unit 1405 includes special purpose components for modem processing, baseband processing, digital signal processing, or transmission processing. According to some aspects, processor unit 1405 comprises one or more processors described with reference to FIG. 13.

Memory unit 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1405 to perform various functions described herein.

In some cases, memory unit 1410 includes a basic input/output system (BIOS) that controls basic hardware or software operations, such as an interaction with peripheral components or devices. In some cases, memory unit 1410 includes a memory controller that operates memory cells of memory unit 1410. For example, the memory controller may include a row decoder, column decoder, or both. In some cases, memory cells within memory unit 1410 store information in the form of a logical state. According to some aspects, memory unit 1410 is an example of the memory subsystem 1310 described with reference to FIG. 13.

According to some aspects, image processing apparatus 1400 uses one or more processors of processor unit 1405 to execute instructions stored in memory unit 1410 to perform functions described herein. For example, the image processing apparatus 1400 may obtain an input prompt and an indication of a first image generation mode; select a first image generation model from a set of image generation models including the first image generation model and a second image generation model, wherein the first image generation model corresponds to the first image generation mode and the second image generation model corresponds to the second image generation mode different from the first image generation mode; and generate, using the first image generation model, a synthetic image based on the input prompt.

In one aspect, memory unit 1410 includes image generation model 1415 trained to obtain an input prompt and an indication of a first image generation mode; select a first image generation model from a set of image generation models including the first image generation model and a second image generation model, wherein the first image generation model corresponds to the first image generation mode and the second image generation model corresponds to the second image generation mode different from the first image generation mode; and generate, using the first image generation model, a synthetic image based on the input prompt. For example, after training, the image generation model 1415 may perform inferencing operations as described with reference to FIGS. 1-3 to obtain an input prompt and an indication of a first image generation mode; select a first image generation model from a set of image generation models including the first image generation model and a second image generation model, wherein the first image generation model corresponds to the first image generation mode and the second image generation model corresponds to the second image generation mode different from the first image generation mode; and generate, using the first image generation model, a synthetic image based on the input prompt.

In some embodiments, the image generation model 1415 is an Artificial neural network (ANN) comprising a plurality of networks including the guided diffusion model described with reference to FIG. 7 and the U-Net described with reference to FIG. 8. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image generation model 1415 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1425 may train the image generation model 1415. For example, parameters of the image generation model 1415 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 11). The goal of the training process may be to find optimal values for the parameters that allow the image generation model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 1415 can be used to make predictions on new, unseen data (i.e., during inference).

According to some aspects, image generation model 1415 obtains an input prompt. In some aspects, the input prompt describes a scene, and the generated synthetic image depicts aspects of the input prompt. In some examples, image generation model 1415 obtains an indication of the fast image generation mode.

According to some aspects, image generation model 1415 is comprising parameters stored in the at least one memory component, wherein the image generation model 1415 comprises a distilled diffusion network trained to quickly and accurately generate a synthetic image based on a text prompt.

According to some aspects, image generation model 1415 obtains an input prompt describing a scene and an indication of a fast mode. In some examples, image generation model 1415 generates a synthetic image based on the indication and the input prompt. In some aspects, the image generation model 1415 includes a diffusion network (such as diffusion network described with reference to FIGS. 7-10).

I/O module 1420 receives inputs from and transmits outputs of the image processing apparatus 1400 to other devices or users. For example, I/O module 1420 receives inputs for the image generation model 1415 and transmits outputs of the image generation model 1415. According to some aspects, I/O module 1420 is an example of the I/O interface 1320 described with reference to FIG. 13.

FIG. 15 shows an example of an image generation model 1500 according to aspects of the present disclosure. In one aspect, image generation model 1500 includes first image generation model 1505 and user interface 1510.

According to some aspects, first image generation model 1505 generates a synthetic image based on the input prompt. In some aspects, the first image generation mode includes an accelerated image generation mode (e.g., fast mode). In some aspects, the first image generation model 1505 includes a distillation of the second image generation model. In some examples, first image generation model 1505 upscales the synthetic image from the first image resolution based on the first image generation mode.

In some examples, first image generation model 1505 generates a set of synthetic images including the synthetic image, where each of the set of synthetic images depicts a same image element from the input prompt. In some examples, first image generation model 1505 obtains a noise input. In some examples, first image generation model 1505 denoises the noise input based on the input prompt. First image generation model 1505 is an example of, or includes aspects of, the corresponding element described with reference to FIGS. 10-12 and 14.

According to some aspects, user interface 1510 obtains an input prompt and an indication of a first image generation mode. In some examples, user interface 1510 selects a first image generation model from a set of image generation models including the first image generation model and a second image generation model, where the first image generation model corresponds to the first image generation mode and the second image generation model corresponds to the second image generation mode different from the first image generation mode. In some examples, user interface 1510 provides a mode selection user interface element.

User interface 1510 is an example of, or includes aspects of, the corresponding element described with reference to FIGS. 3-6. In one aspect, user interface 1510 includes mode selection user interface element 1515. Mode selection user interface element 1515 is an example of, or includes aspects of, the corresponding element described with reference to FIG. 3. In one aspect, mode selection user interface element 1515 includes toggle switch 1520. Toggle switch 1520 is an example of, or includes aspects of, the corresponding element described with reference to FIG. 3.

According to some aspects, mode selection user interface element 1515 receives the indication from a user. In some examples, mode selection user interface element 1515 selects a first image resolution for the synthetic image based on the indication of the first image generation mode, where the first image resolution corresponds to the first image generation mode and is different from a second image resolution that corresponds to the second image generation mode.

In some aspects, the mode selection user interface element 1515 includes a toggle switch 1520 for switching between the first image generation mode and the second image generation mode. Mode selection user interface element 1515 is an example of, or includes aspects of, the corresponding element described with reference to FIG. 3. Toggle switch 1520 is an example of, or includes aspects of, the corresponding element described with reference to FIG. 3.

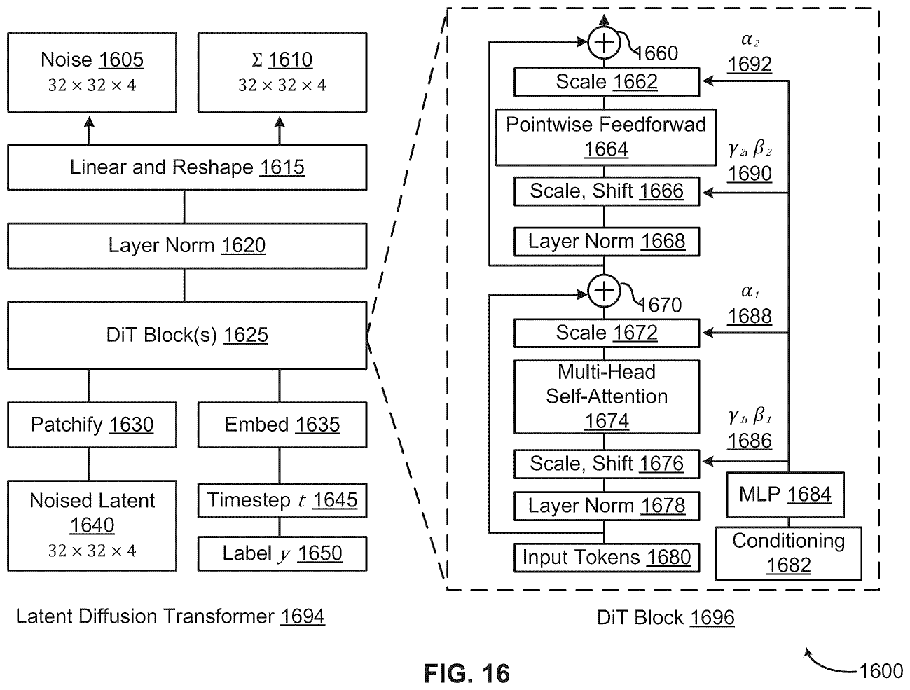

FIG. 16 shows an example of a diffusion transformer (DiT) architecture 1600 according to aspects of the present disclosure. The example shown includes predicted noise 1605, predicted covariance 1610, linear and reshape layers 1615, normalization layer 1620, DiT block(s) 1625, patchify operation 1630, embedding 1635, noised latent 1640, timestep information 1645, label information 1650, and an implementation of one block in the DiT block(s) 1625 by a DiT Block 1696. The DiT Block 1696 includes: second residual connection 1660, second scaling operations 1662, feed-forward network 1664, post-normalization second scaling and shifting 1666, second normalization 1668, first residual connection 1670, first scaling operations 1672, self-attention 1674, post-normalization first scaling and shifting 1676, first normalization 1678, input tokens 1680, conditioning tokens 1682, multi-layer perceptron (MLP) 1684, post-normalization first scaling and shifting parameters 1686, first scaling parameter 1688, post-normalization second scaling and shifting parameters 1690, and second scaling parameter 1692. In some embodiments, the architecture employes an Latent Diffusion Transformer 1694. In some embodiments, DiT Block 1696 employs an “adaLN-Zero” technique.

Diffusion Transformers (DiTs) is a popular architecture for diffusion models and is designed to be structurally faithful to standard transformer architecture. DiT incorporates transformer structures' scaling properties. For training denoising diffusion probabilistic models (DDPMs) of images (e.g., spatial representations of images), DiT is based on a Vision Transformer (ViT) architecture which operates on sequences of patches. DiT processes images by dividing them into patches, converting these patches into tokens, and applying attention mechanisms to model relationships between different regions of the image. This approach allows the model to capture both local and long-range dependencies in the image generation process.

In some cases, input to DiT is a spatial representation z. For 256×256×3 images, z has shape 32×32×4. A first layer of a DiT is to carry out patchify operation, where the DiT divides an input image into patches and converts the patches (a form of spatial input) into a sequence of T tokens, each of dimension d, by linearly embedding each patch in the input. Following the patchify process, ViT frequency-based positional embeddings are applied to all input tokens. In some cases, the number of tokens T created by patchify is determined by a patch size hyperparameter p. In some cases, T=(I/p)², where I is another shape parameter, thus halving p will quadruple T, which in some cases at least quadruples total of transformer Giga Floating Point Operations (Gflops). In some examples, changing p has no impact on downstream parameter counts, i.e., parameter counts in downstream layers of DiT is independent from p. In some examples, p=2, 4 or 8. Various patch sizes, transformer block architectures and model sizes are implemented.

Following Patchify operation, attention mechanisms are applied to model relationships between different regions of the image in one or more DiT blocks. In addition to noised image inputs, diffusion models sometimes process additional conditional information such as noise timesteps t, class labels c, natural language information, etc. Four variants of transformer blocks for processing conditional inputs including both input information and conditional information are described below.

In some cases, DiT blocks in the DiT network are implemented using adaptive layer norm (adaLN) blocks. Following adaptive normalization layers in generative adversarial networks (GANs) and conventional diffusion models with U-Net backbones, in some examples, standard normalization layers in transformer blocks are replaced with adaptive layer norm (adaLN). Rather than directly learning dimension-wise scale γ and shift parameters β , in adaLN the system regresses γ and β from a sum of the embedding vectors of the noise timesteps t and the class labels c. An adaLN adds relatively small numbers of Gflops and is more efficient. Additionally, adaLN is a conditioning mechanism that applies a same function to all tokens.

In some cases, DiT blocks in the DiT network are implemented using adaLN-Zero blocks, which leverages zero-initialization techniques. In Residual Networks (ResNets), initializing each residual block as the identity function x→x is beneficial. In some examples, zero-initializing a final batch norm scale factor y in each block accelerates large-scale training in supervised learning settings. Diffusion models based on U-Nets use a similar initialization strategy, zero-initializing final convolutional layer in each block prior to residual connections. An adaLN-Zero block is modified from an adaLN block using similar zero-initialization techniques. In addition to regressing the dimension-wise scale γ and the shifting parameters β, the system also regresses dimension-wise scaling parameters as that are applied immediately prior to residual connections within the DiT block. The network initializes a multi-layer perceptron (MLP) to output a zero-vector for all αs; this initializes an entire DiT block as the identity function. As with the adaLN block, adaLNZero adds negligible Gflops to the model.

In some cases, DiT blocks in the DiT network are implemented using in-context conditioning, where vector embeddings of t and c are appended as two additional tokens in the input sequence, and after a final block, the network removes the two conditioning tokens from the sequence.

In some cases, DiT blocks in the DiT network include cross-attention blocks. The DiT network concatenates the embeddings of t and c into a length-two sequence, separate from the image token sequence. The transformer block is modified to include an additional multi-head cross-attention layer following the multi-head self-attention block.

In some cases, the DiT network includes a sequence of N DiT blocks, each operating at a hidden dimension size d. Following ViT, the DiT network uses standard transformer configs that jointly scale N, d and attention heads. In some examples, Small(S), Base (B), Large (L) variants, XLarge (XL) variants of model sizes are implemented. Small or Base model sizes have N=12 layers of DiT blocks, Large model sizes have 24 layers of DiT blocks. XLarge model sizes have 28 layers of DiT blocks.

After a final DiT block, the DiT network decodes the sequence of image tokens into an output noise prediction and an output diagonal covariance prediction. Both outputs have shape equal to an original spatial input. Standard linear decoder is utilized to decode, wherein a final normalization layer (or adaptive normalization layer if the DiT block is an adaLN block) and linearly decode each token into a p×p×2C tensor, where C is a number of channels in the spatial input to the DiT network and p is the patch size hyperparameter. Finally, decoded tokens are rearranged into their original spatial layout to get the predicted noise and covariance.

The architecture 1600, in some cases, employs a Latent Diffusion Transformer 1694. The architecture 1600 processes noised latent 1640, which may be a noised version of an input image encoded in a latent space. Patchify operation 1630 divides the noised latent into a sequence of patches that are processed as tokens. The tokens are vector representations of each patch of the image in latent space and are adjusted through attention processes. Each of the tokens also receives timestep information 1645 and label information 1650 and, accordingly, their embedding 1635, which encodes the current denoising timestep and class labels as conditional information. In some cases, embedding 1635 is referred to as conditional embedding or conditional information embedding. In some cases, a positional embedding which encodes each token's spatial position in the image is applied to the patchified input tokens at the patchify operations 1630. In some examples the positional embedding is ViT frequency-based positional embedding. The input tokens 1680 generated by the patchify operation 1630 and the conditioning tokens 1682 generated by the embedding 1635 are processed through N DiT block(s) 1625, where N may be 12, 24 or 28. Other values of N may be used. In some cases, conditional tokens refer to tokens generated based on embedding 1635 encoding timestep information 1645 and label information 1650.

Each of the DiT block(s) 1625 includes multiple processing stages. DiT Block 1696 illustrates an embodiment of one block in the DiT block(s) 1625. In some embodiments, the DiT Block 1696 is an example of, or includes aspects of, the adaLN-Zero block. In some cases, input tokens 1680 interact with the conditioning tokens 1682 through multiple attention mechanisms. Particularly, after first normalization 1678 applied to the input tokens and MLP 1684 to the conditional tokens, MLP 1684 generates or updates post-normalization first scaling and shifting parameters 1686, denoted as γ₁, β₁, for post-normalization first scaling and shifting 1676 to scale and shift the output of first normalization 1678 accordingly. As the normalized input tokens obtained from first normalization 1678 are scaled and shifted at post-normalization first scaling and shifting 1676 using the conditional information carried as least in γ₁, β₁, this allows the input information and conditional information to interact. Self-attention 1674 allows the scaled and shifted normalized input tokens, namely the output from post-normalization first scaling and shifting 1676, to attend to each other. MLP 1684 also generates or updates first scaling parameter 1688 denoted as α₁ for first scaling operations 1672 to scale the output of self-attention 1674 (e.g., multi-head self-attention), further interacting the input information and conditional information. The input tokens 1680 is then summed with the output of first scaling operations 1672 at first residual connection 1670. In some examples, α₁ has initial values 0, and the DiT Block 1696 is initialized as the identity function.

A similar process is performed in a second half of the DiT Block 1696. MLP 1684 generates or updates post-normalization second scaling and shifting parameters 1690, denoted as γ₂, β₂, for post-normalization second scaling and shifting 1666 to scale and shift the output of second normalization 1668 accordingly. As the output from second normalization 1668 is scaled and shifted using the conditional information carried at least in γ₂, β₂, this allows the input information and conditional information to further interact. Feed-forward network 1664 then processes the scaled and shifted output from post-normalization second scaling and shifting 1666. MLP 1684 also generates or updates second scaling parameter 1692 denoted as α₂ for second scaling operations 1662 to scale the output of feed-forward network 1664, further interacting the input information and conditional information. In some cases, the feed-forward network 1664 is a pointwise feed-forward network. The output from first residual connection 1670 is then summed with the output of second scaling operations 1662 at second residual connection 1660, and the result is the final output of DiT Block 1696. In some examples, α₂ has initial values 0, and the DiT Block 1696 is initialized as the identity function. This process repeats for each DiT block in the sequence.

After processing through all DiT block(s) 1625, the outputs undergo normalization layer 1620 followed by linear and reshape layers 1615. The final output is the predicted noise 1605, which represents the model's prediction of the noise that was added to initially create the noised latent 1640, and the predicted covariance 1610, which represents the model's prediction of the covariance. The predicted noise 1605 is removed from noised latent 1640 at each diffusion timestep, and the predicted covariance may affect how noise is removed or resampled in the reverse or denoising process. At the end of the denoising schedule, the latent sample is decoded to generate the synthetic image in pixel space.

The description and drawings described herein represent example configurations and do not represent all the implementations within the scope of the aspects. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following aspects, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt and an indication of a first image generation mode;
selecting a first image generation model from a set of image generation models including the first image generation model and a second image generation model based on the input prompt, wherein the first image generation model corresponds to the first image generation mode and the second image generation model corresponds to the second image generation mode different from the first image generation mode; and
generating, using the first image generation model, a synthetic image based on the input prompt and the first image generation mode.

2. The method of claim 1, wherein obtaining the indication of the first image generation mode comprises:
providing a mode selection user interface element; and
receiving the indication from a user via the mode selection user interface element.

3. The method of claim 1, wherein:
the first image generation mode comprises an accelerated image generation mode.

4. The method of claim 1, wherein:
the first image generation model comprises a distillation of the second image generation model.

5. The method of claim 1, further comprising:
selecting a first image resolution for the synthetic image based on the indication of the first image generation mode, wherein the first image resolution corresponds to the first image generation mode and is different from a second image resolution that corresponds to the second image generation mode.

6. The method of claim 5, further comprising:
upscaling the synthetic image from the first image resolution based on the first image generation mode.

7. The method of claim 1, wherein generating the synthetic image comprises:
generating a plurality of synthetic images including the synthetic image, wherein each of the plurality of synthetic images depicts a same image element from the input prompt.

8. The method of claim 1, wherein generating the synthetic image comprises:
obtaining a noise input; and
denoising the noise input based on the input prompt.

9. A non-transitory computer readable medium storing code for image processing, the code comprising instructions that, when executed by at least one processor, cause the at least one processor to perform operations comprising:
displaying a mode selection user interface element to a user;
obtaining an indication of a first image generation mode from the user via the mode selection user interface element;
selecting a first image generation model based on the first image generation mode; and
generating, using the first image generation model, a synthetic image according to the first image generation mode.

10. The non-transitory computer readable medium of claim 9, wherein:
each of a plurality of image generation models corresponds to a different image generation mode in the mode selection user interface element.

11. The non-transitory computer readable medium of claim 9, wherein:
the first image generation mode comprises an accelerated image generation mode.

12. The non-transitory computer readable medium of claim 9, wherein:
the first image generation model comprises a distillation of a second image generation model of a plurality of image generation models.

13. The non-transitory computer readable medium of claim 9, the code further comprising instructions that, when executed by the at least one processor, causes the at least one processor to perform operations comprising:
selecting a first image resolution for the synthetic image based on the indication of the first image generation mode, wherein the first image resolution corresponds to the first image generation mode and is different from a second image resolution that corresponds to a second image generation mode.

14. The non-transitory computer readable medium of claim 13, the code further comprising instructions that, when executed by the at least one processor, causes the at least one processor to perform operations comprising:
upscaling the synthetic image from the first image resolution based on the first image generation mode.

15. The non-transitory computer readable medium of claim 9, wherein generating the synthetic image comprises:
generating a plurality of synthetic images including the synthetic image, wherein each of the plurality of synthetic images depicts a same image element from the input prompt.

16. The non-transitory computer readable medium of claim 9, wherein generating the synthetic image comprises:
obtaining a noise input; and
denoising the noise input based on the input prompt.

17. A system comprising:
a memory component; and
a processing device coupled to the memory component, the processing device configured to perform operations comprising:
obtaining an input prompt and an indication of a first image generation mode;
selecting a first image generation model from a set of image generation models including the first image generation model and a second image generation model, wherein the first image generation model corresponds to the first image generation mode and the second image generation model corresponds to the second image generation mode different from the first image generation mode; and
generating, using the first image generation model, a synthetic image based on the input prompt and the first image generation mode.

18. The system of claim 17, wherein obtaining the indication of the first image generation mode comprises:
providing a mode selection user interface element; and
receiving the indication from a user via the mode selection user interface element.

19. The system of claim 18, wherein:
the mode selection user interface element comprises a toggle switch for switching between the first image generation mode and the second image generation mode.

20. The system of claim 17, further comprising:
a user interface configured to obtain the input prompt and the indication of the first image generation mode.
